(19) United States
(12) Patent Application Publication
(10) Pub. No.: US 2003/0004757 A1
(43) Pub. Date: Jan. 2, 2003

(54) Facility and a method of operating a facility for providing care

(76) Inventor: Jack J. Haines, McKeesport, PA (US)

Correspondence Address: HENRY E. BARTONY, JR., LAW & FINANCE BUILDING, SUITE 1801, 429 FOURTH AVENUE, PITTSBURGH, PA, 15219, US

(21) Appl. No.: 10/184,581

(22) Filed: Jun. 28, 2002

Related U.S. Application Data
(60) Provisional application No. 60/302,321, filed on Jun. 29, 2001.

(51) Int. Cl. G06F 17/60

(52) U.S. Cl. 705/2

(57) ABSTRACT

A facility for providing care to debilitated patients includes a residence area staffed with health care professionals and a plurality of areas having different entertainment themes. The facility can also includes at least one classroom area. The classroom area can, for example, be used to provide instruction at a grade level commensurate with the ability of the patients. The facility also can include at least one restaurant that is handicap accessible. The restaurant can be staffed by at least one trained health care provider or professional (for example, a nurses' aid). Likewise, a plurality of the staff (for example, the servers) can be trained health care providers. The restaurant can be open to the public. The restaurant can also include an area for feeding and care of pets.

### CROSS-REFERENCE TO RELATED APPLICATION

This application claims the benefit of U.S. Provisional Patent Application Serial No. 60/302,321, filed Jun. 29, 2001, the disclosure of which is incorporate herein by reference.

### BACKGROUND OF THE INVENTION

The present invention relates to a facility and a method of operating a facility for providing care, and especially to a facility and a method of operating a facility for providing care to patients with diminished mental and/or physical capacity (such as Alzheimer patients).

Alzheimer Disease causes gradual breakdown in the nerve cells of the brain. The brain changes and no longer works as it used to. As a result, people with Alzheimer Disease become less and less able to make sense of information from the outside world and to send messages to their bodies. People with Alzheimer Disease become unable to think, remember, understand, and make decisions as before. They generally have trouble with everyday activities such as getting dressed, cooking a meal, or washing the car. Eventually, Alzheimer patients become unable to look after themselves and will develop other illnesses such as pneumonia, which will cause death.

In current care facilities for Alzheimer patients and patients suffering from other debilitating diseases, the safety and health of the patient are primary concerns. However, little effort has been made to improve the quality of life of such patients in terms of their day-to-day enjoyment of their surroundings. Activities are very limited in current facilities. More attention to such quality of life issues would certainly increase patient enjoyment and may be beneficial to their overall health. Moreover, improving the quality of life of these patients may also improve the well being of the family and friends of the patients as placing a loved one in a care facility is typically a traumatic and trying experience that often extends for years.

Statistics indicate that one out of five people will need special care at some point in their lives. It is thus very desirable to develop methods and facilities for caring for patients requiring professional care that improve their quality of life and that of the people closely associated with them.

### SUMMARY OF THE INVENTION

In one aspect, the present invention provides a facility for providing care to debilitated patients including: a residence area staffed with health care professionals and a plurality of areas having different entertainment (for example, festive, holiday, game or sporting) themes (that is, different implicit or recurrent ideas or a motifs). Each of the areas can, for example, have a different theme or one or more themes can be generally repeated in more than one area. In one embodiment, a different holiday theme is provided in each of a plurality of areas. The different areas can be in different structures or buildings or can be located in a single structure. Preferably, one or all of the areas are accessible to patients with generally any affliction (mental or physical) and to generally all age groups (including children). The facility can also include at least one classroom area. The classroom area can, for example, be used to provide instruction at a grade level commensurate with the ability of the patients.

The facility can also include at least one restaurant that is handicap accessible. The restaurant can be staffed by at least one trained health care provider or professional (for example, a nurses' aid). Likewise, a plurality of the staff (for example, the servers) can be trained health care providers. The restaurant can be open to the public. The restaurant can also include an area for feeding and/or care of pets. The area for feeding and care of pets is preferably suitably separated from the restaurant area for the patients.

In another aspect, the present invention provides a method for providing care to debilitated patients comprising: providing a residence area staffed with health care professionals where patients can live; and providing a plurality of areas in the vicinity of the residence area for use by the patients. The area have different entertainment themes as described above. The areas can be open to the public (that is, to non-patients such as family and friends). The method can further includes the steps of providing at least one classroom area and providing instructions to patients at a grade level commensurate with the ability of the patients.

The method can further includes the step of providing at least one restaurant that is handicap accessible (preferably to patient of generally any affliction) and generally caters to handicapped individuals, their family and their friends as described above.

### BRIEF DESCRIPTION OF THE DRAWINGS

Other aspects of the invention and their advantages will be discerned from the following detailed description when read in connection with the accompanying drawings, in which:

FIG. 1 illustrates a schematic representation of one embodiment of a care facility of the present invention.

### DETAILED DESCRIPTION OF THE INVENTION

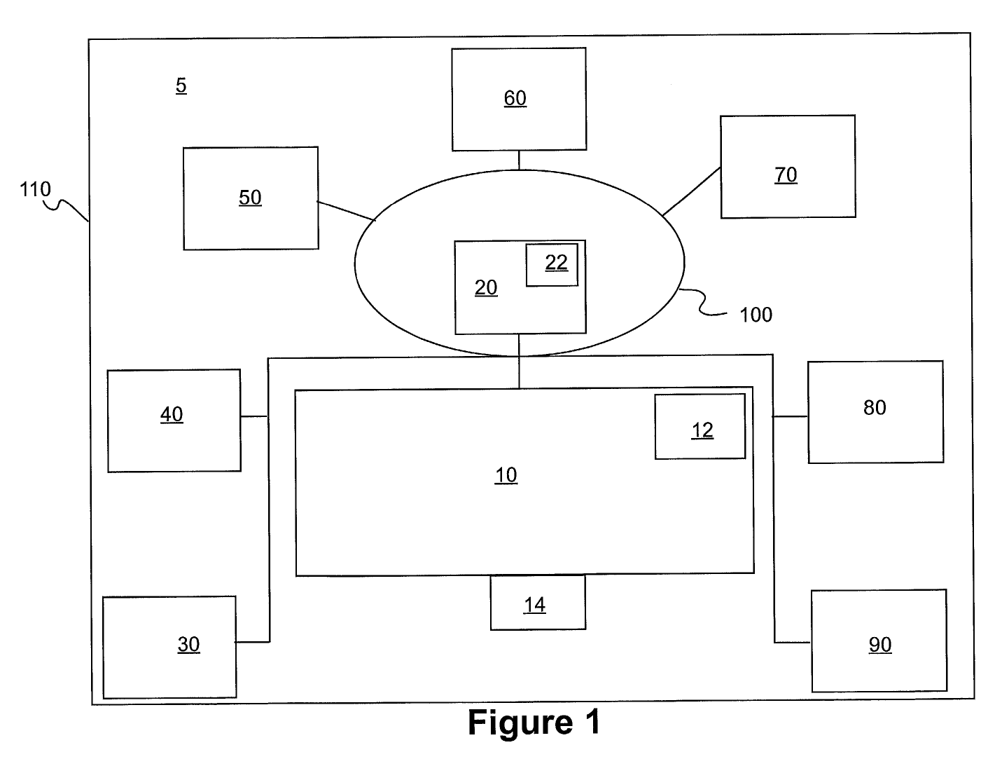

Referring to FIG. 1, the present invention provides a facility 5 including a residence area or building 10 which can include a large lounge, a dining area, and an old-fashioned, grade school classroom 12 (for example, a third-grade classroom) complete with teacher and daily activities for the residents. The residence area can, for example, have on the perimeter of an upper floor or elsewhere therein a plurality of single or double rooms depending on the desired residency capacity. Building 10 can also include meeting rooms, storage, and can include an handicap accessible exit 14. One or more handicap accessible ramps can be provided between different levels or floors making all areas handicap accessible. Handicap accessible elevators can also be provided.

Facility 5 can include a handicap accessible restaurant 20 (for example, a buffet-style restaurant) that caters to the needs and desires of physically and mentally handicapped men, women and children as well as their family and friends. Restaurant 20 can be open to the public and can provide an atmosphere where anyone can bring a loved one, relative, or friend and not be concerned about care provided and not embarrassed in any way. At least one of the servers or other restaurant staff is preferably a trained health care provider or professionals (for example, a nurses' aid) that can assist in substantially any way. Preferably, a plurality of the servers or other restaurant staff are trained health care providers.

The menu of restaurant 20 can, for example, include some regular diet items and some special, for example, soft, diet items—preferably at affordable prices. The main staff and nurses of facility 5 are preferably on call for any emergency. Restaurant 20 can, for example, provided with a decor, motif or theme that appeals to a child's mind. For example, restaurant 20 can be designed to resemble a scaled-down castle.

Pets are may be allowed in restaurant 20. Preferably, a separate pet facility 22 is provided with a pet dining room where the pets can eat their dinner and/or be attended to while the patrons are enjoying their meal.

In many instances, at least 50 percent of the restaurant clientele will be wheelchair bound and/or have incontinence problems. Suitable exits, bathrooms and dining tables can be provided for such clientele. Bathrooms can, for example, include changing tables for the incontinent.

In the embodiment of FIG. 1, along the outer perimeter of facility 5 are constructed or provided a plurality (seven in the embodiment of FIG. 1) of areas 30, 40, 50, 60, 70, 80 and 90. Each of areas 30 through 90 can be decorated or otherwise designed around an entertainment theme, for example, a sporting, game, festive or holiday theme. Areas 30 through 90 can, for example be chalet-style shops. Example of themes for areas 30 through 90 include religious holidays, secular holidays and national holidays (for example, New Years Day, President's Day, Easter, Fourth of July, Halloween, Thanksgiving and Hanukah and Christmas). The holiday and/or other themes preferably include items or area that the residents (for example, Alzheimer patients) will especially enjoy or to which they will relate well such as: a candy shop; pet supplies, craft shop, etc. These themes will greatly increase the activities for residents as compared to current care facilities.

In one embodiment, the entire or overall theme of the complex is constructed with a Holiday or multi-Holiday theme so that adults and children afflicted with terrible diseases and physical problems that are difficult, or impossible, to cure may enjoy a holiday season or different holiday seasons at any time of year.

A walkway or pathway 100 can connect the various elements or components of faculty 5. An outer perimeter 110 (for example, fencing) can surround facility 5 as known in the art. The components or areas of facility 5 can be constructed as separate buildings or structures or can be placed in a single building.

A portion of any profits from the restaurant and village/theme shops, can, for example, be used to fund residents on low-income so that they are able to afford required care.

Although the present invention has been described in detail in connection with the above examples, it is to be understood that such detail is solely for that purpose and that variations can be made by those skilled in the art without departing from the spirit of the invention except as it may be limited by the following claims.

What is claimed is:

1. A facility for providing care to debilitated patients comprising:
a residence area staffed with health care professionals; and
a plurality of areas having a different entertainment themes.

2. The facility of claim 1 wherein the entertainment themes are selected from sporting themes, game themes, festive themes or holiday themes.

3. The facility of claim 2 wherein the themes are holiday themes.

4. The facility of claim 1 further including at least one classroom area, the classroom area being used to provide instruction a grade level commensurate with the ability of the patients.

5. The facility of claim 1 further including at least one restaurant, the restaurant being handicap accessible.

6. The facility of claim 5 wherein the restaurant is staffed by at least one health care professional.

7. The facility of claim 5 wherein restaurant is open to the public.

8. The facility of claim 5 wherein the restaurant includes an area for feeding and care of pets.

9. A method for providing care to debilitated patients comprising:
providing a residence area staffed with health care professionals where patients can live;
providing a plurality of areas in the vicinity of the residence area for use by the patients, the areas having a different entertainment themes.

10. The method of claim 9 wherein the entertainment themes are selected from sporting themes, game themes, festive themes or holiday themes.

11. The method of claim 10 wherein the themes are holiday themes.

12. The method of claim 9 further including the steps of providing at least one classroom area and providing instructions to patients at a grade level commensurate with the ability of the patients.

13. The method of claim 9 further including the step of providing at least one restaurant that is handicap accessible.

14. The method of claim 13 wherein the restaurant is staffed by at least one health care professional.

15. The method of claim 13 wherein restaurant is open to the public.

16. The method of claim 13 wherein the restaurant includes an area for feeding and care of pets.
